(19) United States
(12) Patent Application Publication
(10) Pub. No.: US 2004/0261880 A1
(43) Pub. Date: Dec. 30, 2004

(54) Tubing system and method of assembly

(75) Inventors: Melvin Kleinsasser, Winnipeg (CA); Ronald Van De Laar, Brandon (CA)

Correspondence Address: ADE & COMPANY, 1700-360 MAIN STREET, WINNIPEG, MB, R3C3Z3, CA

(73) Assignees: Concord Colony Farms Ltd.; Install The Best Canada Ltd.

(21) Appl. No.: 10/875,245

(22) Filed: Jun. 25, 2004

Related U.S. Application Data
(60) Provisional application No. 60/482,441, filed on Jun. 26, 2003.

(51) Int. Cl. F16L 9/00

(52) U.S. Cl. 138/167; 138/166; 138/168

(57) ABSTRACT

Tubing is formed by a rectangular sheet of resilient material which is pliable into a flexed position in which the rectangular sheet has a generally tubular configuration of circular cross section. A pair of elongate mounting strips can be secured along a pair of opposing sides of the rectangular sheet in an assembled position by welding or by integral molding. An elongate clamping member is slidably received in channels within the mounting strips for clamping the mounting strips together.

### FIELD OF THE INVENTION

This application claims priority under 35 U.S.C. 119 from United States Provisional Application Ser. No. 60/482,441 filed Jun. 26, 2003.

The present invention relates to a tubing system and more particularly to a method of assembling the tubing system.

### BACKGROUND

When transporting tubing from a point of manufacture to a point of distribution or installation, considerable cost is incurred because of the volume required for the tubing to occupy despite the relative low mass of the product being transported. This is especially true when transporting larger tubing which may vary from 8 inches to 48 inches in diameter as well as even larger tubing.

One example of tubular covering for a cable which can be assembled appears in U.S. Pat. No. 4,860,799 to Van Noten which discloses a closure for a wraparound sleeve. The sleeve includes clips for securement of opposing edges for small applications such as wrapping wires and the like. Such a configuration could not readily be applied to larger tubing as the extruded shape would be cost prohibitive. Furthermore the resulting tubing would have an awkward profile which would be difficult to seal against a supporting surface through which the tubing extends in certain applications.

### SUMMARY

According to one aspect of the present invention there is provided a tubing system comprising:

a rectangular sheet formed of resilient material which is pliable into a flexed position in which the rectangular sheet has a generally tubular configuration of circular cross section;

a pair of elongate mounting strips along a pair of opposing sides of the rectangular sheet in an assembled position; and

a clamping member for clamping the mounting strips together in the assembled position and thereby secure the rectangular sheet in the flexed position;

the mounting strips including channels formed therein for slidably receiving opposing flanges of the clamping member therein.

The use of mounting strips permits grooves or channels to be formed along opposing edges of the sheet such that a low profile clamping member can be received therein which fits substantially flush with the outer surface of the tube. Such an arrangement readily permits sealing against a surround surface through which the tubing extends in an assembled position. By assembling the tubing from a resilient rectangular sheet with suitable clamping, tubing according to the present invention can be shipped in a flat rectangular form occupying a relatively small shipping volume. The tubing can subsequently be readily assembled when insulation is required.

The clamping member preferably extends substantially a full length of the mounting strips.

Each mounting strip may be gradually reduced in thickness from a first end locating the channel therein to a second end directly adjacent the rectangular sheet.

The rectangular sheet is preferably plural times a thickness of the clamping member such that the resulting clamping member is very thin and of low profile.

The channel preferably has both a lateral extent and a vertical extent slidably receiving the clamping member therein.

A cover member may be formed on the clamping member having a convex outer surface and which is formed integrally with the clamping member. The cover member preferably spans outwardly from the clamping member to respective free edges having a thickness which is less than the sheet.

According to a second aspect of the present invention there is provided a tubing system comprising:

a rectangular sheet formed of resilient material which is pliable into a flexed position in which the rectangular sheet has a generally tubular configuration of circular cross section;

a pair of elongate mounting strips for respective securement along a pair of opposing sides of the rectangular sheet in an assembled position;

a clamping member for clamping the mounting together in the assembled position and thereby secure the rectangular sheet in the flexed position.

There may be provided a cover member having a smooth outer profile arranged to blend with an outer surface of the rectangular sheet in the assembled position wherein the cover member and the clamping member are mounted together.

The mounting strips are preferably thicker in cross section than the sheet and include a channel formed therein for slidably receiving opposing mounting flanges of the clamping member respectively.

The mounting strips may include a tapered mounted edge having a similar thickness as the sheet which abuts the sheet in the assembled position.

The sheet and the mounting strips are preferably formed of similar plastic material which may be fused together by butt-welding in the assembled position.

The tubing system may be supported in combination with a fan housing supported in communication with the rectangular sheet in the assembled position.

According to a further aspect of the present invention there is provided a method of assembling a tubing system comprising:

providing a rectangular sheet formed of resilient material;

forming a pair of elongate mounting strips along a pair of opposing sides of the rectangular sheet;

bending the rectangular sheet into a flexed position in which the rectangular sheet has a generally tubular configuration of circular cross section and in which the mounting strips extend alongside one another;

providing a clamping member; and

clamping the pair of elongate mounting strips together by slidably mating the clamping member into the channels in the mounting strips.

The method may include forming a cover member on the clamping member having a convex outer surface.

The method may also include extending the cover member substantially a full length of the mounting strips.

### BRIEF DESCRIPTION OF THE DRAWINGS

In the accompanying drawings, which illustrate exemplary embodiments of the present invention:

FIG. 1 is a perspective view of the components of the tubing system shown in a disassembled position.

FIG. 2 is a sectional view of the assembled tubing system.

FIG. 3 is a perspective view of the tubing system during assembly.

FIGS. 4 through 8 illustrate various further embodiments of the clamping member and mounting strips.

### DETAILED DESCRIPTION

Referring to the accompanying drawings, there is illustrated a tubing system generally indicated by reference 10. The system is particularly useful for large lightweight tubing, possibly in the order of 8 to 48 inches in diameter, similarly to ventilation tubing of the type used in the roof 12 of a building to be ventilated for example.

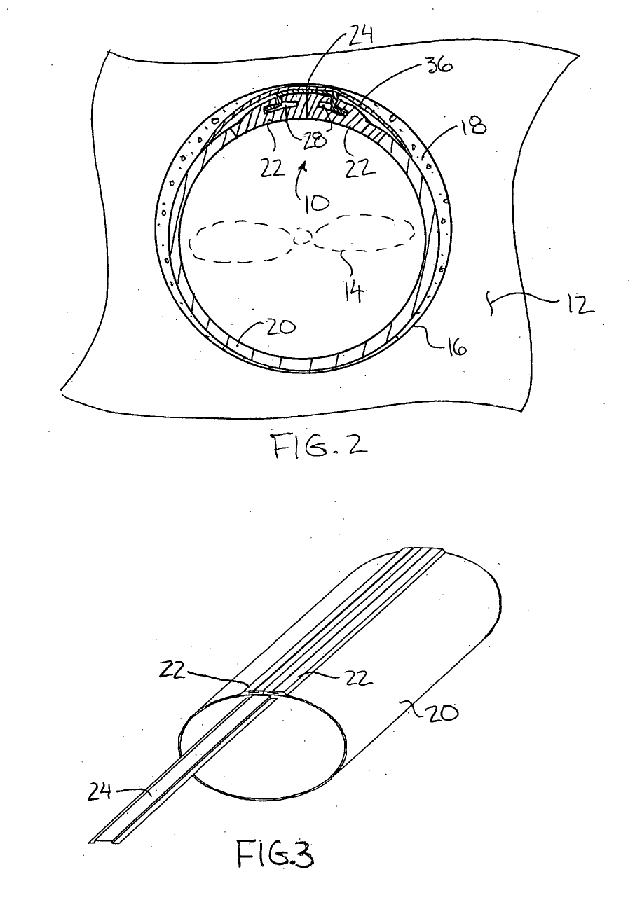

When the tubing is used for ventilation, a fan 14 is preferably housed for rotation therein. The tubing formed by the components of the tubing system 10 is suitably arranged for mounting in the round hole 16 in a supporting surface mounting the tubing therein. Suitable sealant 18 is provided between the tubing formed by the tubing system 10 and the round hole 16 when mounted in a supporting surface as shown in FIG. 2.

The tubing system includes a sheet 20 which is rectangular in shape and has suitable hardness so as to remain somewhat resilient and pliable so as to be bent into a flexed position as illustrated in FIG. 2. In the flexed position the rectangular sheet, formed of a durable plastic, for example high density polyethylene normally lying flat, forms a tube having a circular cross section in which the interior surface has a smooth continuous circular profile. The sheet 20 is thus suitably arranged for receiving the fan 14 therein as shown in FIG. 2 with a preferable clearance in the order of 5% of the diameter of the fan with a minimum ½ inch spacing between the fan and the interior space of the rectangular sheet.

A pair of mounting strips 22 are provided for securement to opposing sides of the sheet 20. In some embodiments the mounting strips and sheet are formed of a similar plastic material such that the mounting strips 22 may be seamless butt fused to the sides of the sheet in an end to end manner so that the inner surfaces of the tube formed by the rectangular sheet 20 is smooth and flush. Alternatively, the mounting strips 22 and the sheet may be integrally formed with one another as illustrated in FIG. 8 by molding, extrusion or other plastic forming operations.

In the assembled position as shown in FIG. 2 the strips 22 lie alongside one another along respective sides of the sheet. The mounting strips are held abutted against one another in the assembled and flexed position by a clamping member 24. The clamping member 24 is suitably arranged to mate with the mounting strips 22 such that the outer profile of the assembled tube is substantially smooth and continuous following a generally convex contour.

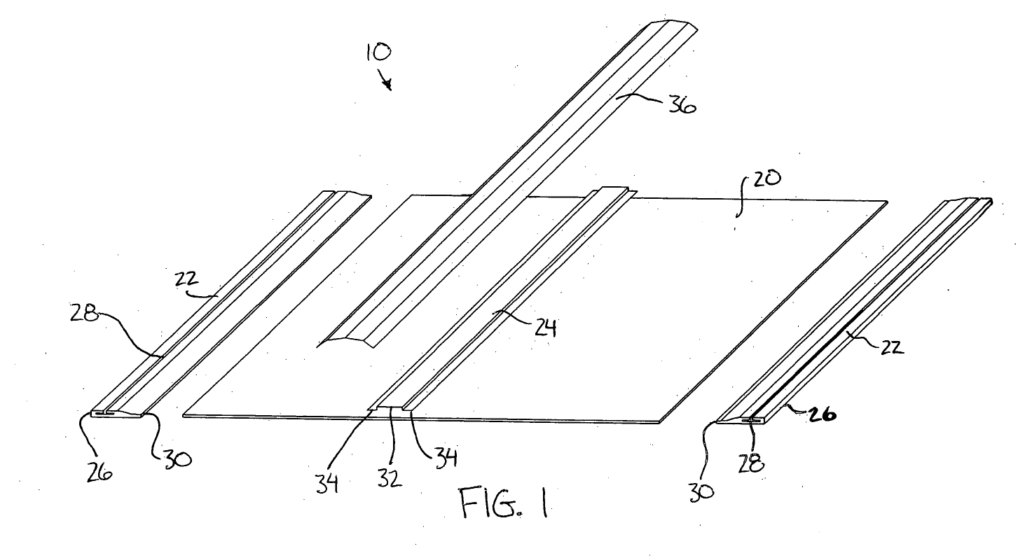

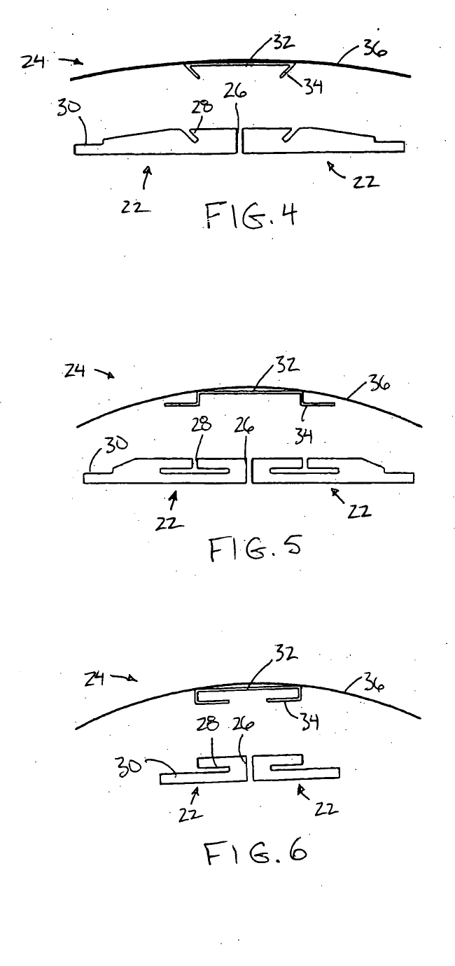

The mounting strips may be thicker than the sheet 20 at an abutted end 26 as shown in FIGS. 1 through 7, or alternatively, the abutted ends and the sheet may be of similar thickness, for example when the strips and sheet are integrally formed.

While various embodiments of the mounting strips and clamping member are shown in the accompanying figures, the common elements of all embodiments will first be described herein. In each instance the mounting strip is thicker than the sheet 20 at an abutted end 26. A mounting channel 28 is provided formed within the mounting strip in the form of a longitudinally extending slot which includes a downward extent extending into the strip from the outer surface to a terminal end within the body of the mounting strip and a lateral extent projecting generally in the direction of the plane of the outer surface of the sheet to which the mounting strip is attached.

The clamping member 24 in each instance includes a main portion 32 and a pair of opposing flanges 34 which are slidably received within the corresponding slots of an abutted pair of the mounting strips. The clamping member is formed of a thin and rigid sheet metal so as to be considerably thinner than the mounting strips and the tubing sheet which are formed of similar plastic material for butt welding.

Each mounting strip, in embodiments of 1 through 7, includes a flat end portion 30 opposite the abutted end 26 which is narrower in thickness so as to have an identical thickness to that of the sheet 20, for example 3 or 4 millimetres for 20 inch or 36 inch diameter tubing respectively, for ease of butt welding onto opposing edges of the sheet. The abutted end 26 for abutment with the opposing mounting strip may be in the order of ¾ to ½ an inch thick. Alternatively, in the embodiment of FIG. 8, no flat end portion narrower in thickness is required when the mounting strips and the sheet are integrally moulded.

Turning now to the embodiments of FIGS. 1 and 5, the mounting strips have a similar thickness on opposing sides of the mounting channel 28 for a low profile mounting of the clamping member therein by extending the slot inwardly from the broad outer surface of the mounting strip. The thickness gradually tapers towards the flat mounting end portion 30 along a smooth and continuous profile. The reduction in thickness of the mounting strips may occur gradually in the circumferential direction of the assembled tube a distance of approximately 4 inches when the sheet is less than ½ inch thick.

The lateral extent of the channel extends perpendicularly to the downward extent to lie parallel to the outer surface of the mounting strip. The lateral extent further is oriented so that the slot of abutted mounted strips extends away from another. The corresponding clamping member 24 which is received therein includes a bend in the opposing flanges 34 such that terminal ends of the flanges lie parallel to one another and project away from one another at an offset spacing from the main portion. Each opposing flange therefore includes a vertical portion and a horizontal portion. The slots forming the channels of FIG. 8 are similarly arranged, but do not include lateral extents which also extend inwardly towards one another form the downward extend as shown in FIGS. 1 and 5.

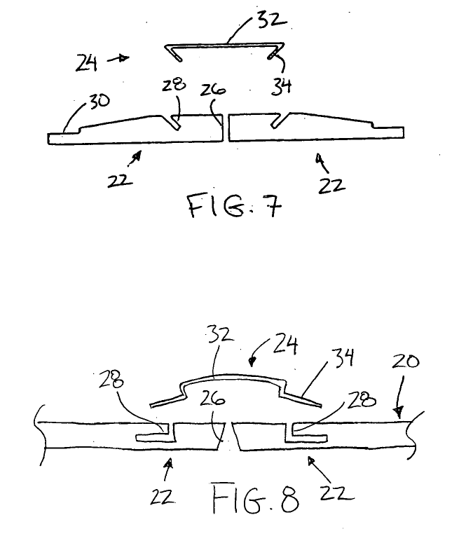

Turning now to further specific embodiments, FIGS. 4 and 7 illustrate identical mounting strips in which thickness of the strip on opposing sides of the slot of the mounting channel 28 is substantially identical so as to have a generally smooth outer surface with low profile mounting of the clamping thereon. Thickness then tapers from the area of the mounting channel 28 at a first end of the mounting strip towards the flat end portion 30 at a second end of the mounting strip. The slot in this instance is inclined toward the opposing abutted mounting strip as it extends inwardly toward the terminal end within the body of the mounting strip such that the opposing flanges 34 of the mating clamping member comprise confronting hooks extending from opposing sides of the main portion of the clamping member at an inclination towards one another.

Referring now to FIG. 6 the slots extend away from each other to face opposite directions at the open end thereof. The corresponding clamping member includes opposed flanges which are parallel and project towards one another along a horizontal extent parallel and spaced from the main portion of the clamping member.

Referring now to the embodiments of FIGS. 1 through 6, the clamping member is provided with a cover portion 36 having a convex outer profile and a concave inner profile which mounts the main portion and opposing flanges therein. The profile of the cover portion is arranged to merge with the outer surface of the assembled tube by providing opposing free ends which project beyond the opposing flanges of the clamping member in opposing lateral directions which correspond to opposing circumferential directions in the assembled tube structure. The opposing free ends have a thin edge for blending with the outer surface of the assembled tube structure.

As shown in FIG. 8, the main portion 32 or the lateral extent of the flanges 34 of the clamping member 24 is curved to follow the same radius of curvature as the assembled tube formed by the tubing system 10. In this instance, the abutted ends 26 of the mounting strips are tapered away from one another as they extend in a radially inward direction of the assembled tube. The tapered edge assists the sheet in forming a more rounded profile in the assembled position.

The clamping member as illustrated is formed of metal but may also be assembled from plastic or a combination thereof. The cover portion 36 and the clamping member are formed in two pieces which are secured together by welding or other suitable means.

While various embodiments of the present invention have been described in the foregoing, it is to be understood that other embodiments are possible within the scope of the invention. The invention is to be considered limited solely by the scope of the appended claims.

1. A tubing system comprising:
a rectangular sheet formed of resilient material which is pliable into a flexed position in which the rectangular sheet has a generally tubular configuration of circular cross section;
a pair of elongate mounting strips along a pair of opposing sides of the rectangular sheet in an assembled position; and
a clamping member for clamping the mounting strips together in the assembled position and thereby secure the rectangular sheet in the flexed position;
the mounting strips including channels formed therein for slidably receiving opposing flanges of the clamping member therein.

2. The system according to claim 1 wherein the clamping member extends substantially a full length of the mounting strips.

3. The system according to claim 1 wherein each mounting strip is gradually reduced in thickness from a first end locating the channel therein to a second end directly adjacent the rectangular sheet.

4. The system according to claim 1 wherein the rectangular sheet is plural times a thickness of the clamping member.

5. The system according to claim 1 wherein the channel has a lateral extent receiving the clamping member therein.

6. The system according to claim 1 wherein the channel has both a lateral extent and a vertical extent receiving the clamping member therein.

7. The system according to claim 1 wherein a cover member is formed on the clamping member having a convex outer surface.

8. The system according to claim 7 wherein the cover member is formed integrally with the clamping member.

9. The system according to claim 7 wherein the cover member spans outwardly from the clamping member to respective free edges having a thickness which is less than the sheet.

10. A tubing system comprising:
a rectangular sheet formed of resilient material which is pliable into a flexed position in which the rectangular sheet has a generally tubular configuration of circular cross section;
a pair of elongate mounting strips for respective securement along a pair of opposing sides of the rectangular sheet in an assembled position;
a clamping member for clamping the mounting together in the assembled position and thereby secure the rectangular sheet in the flexed position.

11. The system according to claim 10 wherein there is provided a cover member having a smooth outer profile arranged to blend with an outer surface of the rectangular sheet in the assembled position.

12. The system according to claim 11 wherein the cover member and the clamping member are mounted together.

13. The system according to claim 10 wherein the mounting strips are thicker in cross section than the sheet.

14. The system according to claim 13 wherein the mounting strips include a channel formed therein for slidably receiving opposing mounting flanges of the clamping member respectively.

15. The system according to claim 13 wherein the mounting strips include a tapered mounted edge having a similar thickness as the sheet which abuts the sheet in the assembled position.

16. The system according to claim 10 wherein the sheet and the mounting strips are formed of similar plastic material fused together in the assembled position.

17. The system according to claim 10 in combination with a fan housing supported in communication with the rectangular sheet in the assembled position.

18. A method of assembling a tubing system comprising:
providing a rectangular sheet formed of resilient material;
forming a pair of elongate mounting strips along a pair of opposing sides of the rectangular sheet;
bending the rectangular sheet into a flexed position in which the rectangular sheet has a generally tubular configuration of circular cross section and in which the mounting strips extend alongside one another;
providing a clamping member; and
clamping the pair of elongate mounting strips together by slidably mating the clamping member into the channels in the mounting strips.

19. The method according to claim 18 including forming a cover member on the clamping member having a convex outer surface.

20. The method according to claim 18 including extending the cover member substantially a full length of the mounting strips.
